(19) United States
(12) Patent Application Publication
(10) Pub. No.: US 2025/0309343 A1
(43) Pub. Date: Oct. 2, 2025

(54) SOLID-STATE BATTERY

(71) Applicant: HONDA MOTOR CO., LTD., Tokyo (JP)

(72) Inventors: Akihiro YOSHIZAWA, Saitama (JP); Yohei NOJI, Saitama (JP); Takashi TOYOSHIMA, Saitama (JP); Kosei MIYATA, Saitama (JP); Shoji TAKAHASHI, Saitama (JP); Kosuke TATSUSHIMA, Saitama (JP)

(21) Appl. No.: 19/064,729

(22) Filed: Feb. 27, 2025

(30) Foreign Application Priority Data
Mar. 29, 2024 (JP) 2024-056384

(51) Int. Cl. H01M 10/0562; H01M 4/62

(52) U.S. Cl. CPC H01M 10/0562; H01M 4/623

(57) ABSTRACT

Provided is a solid-state battery including a solid electrolyte layer properly designed according to a function and having an improved energy density. The solid-state battery has a structure in which a negative electrode layer, a solid electrolyte layer, and a positive electrode layer are laminated in this order. The solid electrolyte layer includes a first solid electrolyte layer, a second solid electrolyte layer, and a third solid electrolyte layer disposed in this order from the positive electrode layer side. The thickness of the first solid electrolyte layer is 3 to 8.5 μm. The thickness of the second solid electrolyte layer is 10 to 20 μm. The thickness of the third solid electrolyte layer is 3 to 8.5 μm. The total thickness of the solid electrolyte layer is 17 to 26 μm.

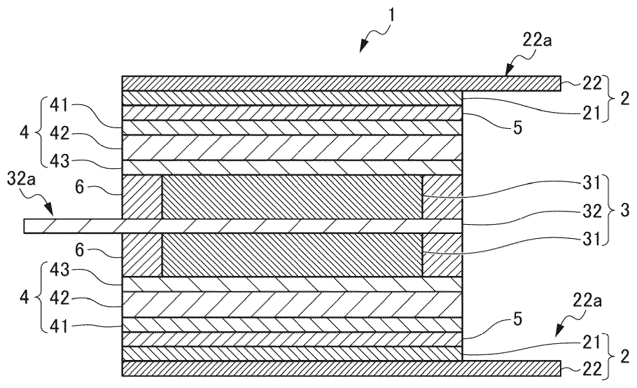

This application is based on and claims the benefit of priority from Japanese Patent Application No. 2024-056384, filed on 29 Mar. 2024, the content of which is incorporated herein by reference.

### BACKGROUND OF THE INVENTION

### Field of the Invention

The present invention relates to a solid-state battery.

### Related Art

In recent years, research and development has been conducted on secondary batteries that contribute to energy efficiency in order to ensure that more people have access to affordable, reliable, sustainable, and advanced energy.

As a secondary battery, a solid-state battery such as a lithium metal battery or a lithium-ion secondary battery has been known, which is configured such that a solid electrolyte layer is disposed between a positive electrode layer and a negative electrode layer.

As a technique related to the solid-state battery, a technique related to an all-solid-state battery having a first solid electrolyte layer adjacent to a negative electrode and a second solid electrolyte layer located between the first solid electrolyte layer and a positive electrode and configured such that the first solid electrolyte layer has a smaller Young's modulus than that of the second solid electrolyte layer has been known (see, for example, Japanese Unexamined Patent Application, Publication No. 2022-108202).
Patent Document 1: Japanese Unexamined Patent Application, Publication No. 2022-108202

### SUMMARY OF THE INVENTION

The technique disclosed in Japanese Unexamined Patent Application, Publication No. 2022-108202 is intended to reduce degradation of interfacial contact between the solid electrolyte layer and the positive and negative electrode layers and suppress a decrease in a voltage upon self-discharge. However, in a case where the solid electrolyte layer is merely formed of the multiple layers, there are problems that the total thickness of the solid electrolyte layer increases and the energy density of the solid-state battery decreases. Moreover, there is also a problem that battery resistance increases due to an interface between the multiple solid electrolyte layers. Further, according to a function required for each of the multiple solid electrolyte layers, for example, the thickness of the solid electrolyte layer needs to be designed properly.

The present invention has been made in view of the above-described situation, and an object thereof is to provide a solid-state battery including a solid electrolyte layer properly designed according to a function and having an improved energy density.

(1) A solid-state battery has a structure in which a negative electrode layer, a solid electrolyte layer, and a positive electrode layer are laminated in this order, in which the solid electrolyte layer includes a first solid electrolyte layer, a second solid electrolyte layer, and a third solid electrolyte layer disposed in this order from the positive electrode layer side, the thickness of the first solid electrolyte layer is 3 to 8.5 μm, the thickness of the second solid electrolyte layer is 10 to 20 μm, the thickness of the third solid electrolyte layer is 3 to 8.5 μm, and the total thickness of the solid electrolyte layer is 17 to 26 μm.

According to the aspect (1) of the invention, the solid-state battery can be provided, which includes the solid electrolyte layer properly designed according to the function and having the improved energy density.

(2) In the solid-state battery according to (1), the content (% by volume) of a binder in the third solid electrolyte layer is equal to or less than the content (% by volume) of a binder in the first solid electrolyte layer and the content (% by volume) of a binder in the second solid electrolyte layer.

According to the aspect (2) of the invention, the first solid electrolyte layer can be stretched so as to follow the positive electrode layer by high-pressure pressing for densifying the positive electrode layer, and the bondability of the second solid electrolyte layer to the other solid electrolyte layers can be improved.

(3) In the solid-state battery according to (1) or (2), the content of the binder in the first solid electrolyte layer is 5% by volume or more and 25% by volume or less.

According to the aspect (3) of the invention, the first solid electrolyte layer can be suitably stretched so as to follow the positive electrode layer by the high-pressure pressing for densifying the positive electrode layer.

(4) In the solid-state battery according to any one of (1) to (3), the first solid electrolyte layer contains a fluorine-based binder.

According to the aspect (4) of the invention, the first solid electrolyte layer can be suitably stretched so as to follow the positive electrode layer by the high-pressure pressing for densifying the positive electrode layer.

(5) In the solid-state battery according to any one of (1) to (4), the content of the binder in the second solid electrolyte layer is 5% by volume or more and 25% by volume or less.

According to the aspect (5) of the invention, the bondability of the second solid electrolyte layer to the other solid electrolyte layers can be improved.

(6) In the solid-state battery according to any one of (1) to (5), the second solid electrolyte layer contains at least any of a fluorine-based binder or a styrene-based binder.

According to the aspect (6) of the invention, the bondability of the second solid electrolyte layer to the other solid electrolyte layers can be improved. Alternatively, ion conductivity can be improved.

(7) In the solid-state battery according to any one of (1) to (6), the content of the binder in the third solid electrolyte layer is 2.7% by volume or more and 10% by volume or less.

According to the aspect (7) of the invention, the third solid electrolyte layer is easily stretchable so as to follow the negative electrode layer.

(8) In the solid-state battery according to any one of (1) to (7), at least any of the first solid electrolyte layer, the second solid electrolyte layer, or the third solid electrolyte layer includes a support.

According to the aspect (8) of the invention, the strength of the solid electrolyte layer is improved, and therefore, the solid electrolyte layer can be decreased in thickness and the energy density of the solid-state battery can be improved.

(9) In the solid-state battery according to any one of (1) to (8), the particle size (D50) of a solid electrolyte layer particle contained in the solid electrolyte layer is 0.1 μm or more and 3 μm or less.

According to the aspect (9) of the invention, both the thickness reduction in the solid electrolyte layer and the preferable ion conductivity can be achieved.

### BRIEF DESCRIPTION OF THE DRAWINGS

A FIGURE is a sectional view showing a solid-state battery according to one embodiment of the present invention.

### DETAILED DESCRIPTION OF THE INVENTION

### Solid-State Battery

As shown in the FIGURE, a solid-state battery 1 has an electrode laminate configured such that a negative electrode layer 2, a solid electrolyte layer 4, and a positive electrode layer 3 are laminated in this order. In the present embodiment, a structure in which the negative electrode layer 2, the solid electrolyte layer 4, the positive electrode layer 3, the solid electrolyte layer 4, and the negative electrode layer 2 are laminated in this order as shown in the FIGURE will be described as the multilayer structure of the solid-state battery 1. However, the structure of the solid-state battery 1 is not limited to above, and the solid-state battery 1 is only required to have a structure in which the solid electrolyte layer 4 is laminated between the negative electrode layer 2 and the positive electrode layer 3.

The solid electrolyte layer 4 in the solid-state battery 1 has at least a first solid electrolyte layer 43 disposed on the positive electrode layer 3 side, a third solid electrolyte layer 41 disposed on the negative electrode layer 2 side, and a second solid electrolyte layer 42 disposed between the first solid electrolyte layer 43 and the third solid electrolyte layer 41. An intermediate layer 5 may be arbitrarily disposed between the negative electrode layer 2 and the solid electrolyte layer 4. In description below, the solid-state battery 1 will be described as one having the intermediate layer 5.

The solid-state battery 1 is not particularly limited but may be a lithium-ion solid-state secondary battery or a lithium metal secondary battery.

### (Solid Electrolyte Layer)

The solid electrolyte layer 4 is formed between the negative electrode layer 2 and the positive electrode layer 3.

The first solid electrolyte layer 43 is disposed on the positive electrode layer 3 side. In the present embodiment, the first solid electrolyte layer 43 is disposed adjacent to a positive electrode active material layer 31 of the positive electrode layer 3. The first solid electrolyte layer 43 is disposed adjacent to the second solid electrolyte layer 42. That is, in the present embodiment, the first solid electrolyte layer 43 is disposed between the positive electrode active material layer 31 and the second solid electrolyte layer 42.

The first solid electrolyte layer 43 is pressed under high pressure together with the positive electrode layer 3 in high-pressure pressing for densifying the positive electrode layer 3. Thus, the first solid electrolyte layer 43 preferably has such properties that the first solid electrolyte layer 43 is stretchable so as to follow the positive electrode layer 3 in the high-pressure pressing.

A solid electrolyte material forming the first solid electrolyte layer 43 is not particularly limited, and is only required to be a material available as an electrolyte of a solid-state battery. For example, the material includes a sulfide solid electrolyte material, an oxide solid electrolyte material, a halide solid electrolyte, an inorganic solid electrolyte such as lithium-containing salt, and a polymer-based solid electrolyte such as polyethylene oxide. The above-described solid electrolytes may be used alone, or two or more types of these solid electrolytes may be used in combination.

The first solid electrolyte layer 43 may contain a material available for a solid electrolyte layer of a solid-state battery in addition to the solid electrolyte material. For example, the first solid electrolyte layer 43 preferably contains a binder. Examples of the binder include a fluorine-based polymer, a nitrile-based polymer, a polyester-based polymer, an acrylate-based polymer, a cellulose-based polymer, a styrene-based polymer, a styrene-butadiene rubber-based (SBR-based) polymer, a vinyl acetate-based polymer, a urethane-based polymer, and the like.

The first solid electrolyte layer 43 preferably contains a fluorine-based binder. Examples of the fluorine-based binder include polyvinylidene fluoride (PVDF) and the like. With this configuration, the stretch of the first solid electrolyte layer 43 can be improved. The content of the binder in the first solid electrolyte layer 43 is preferably 5% by volume or more and 25% by volume or less.

The first solid electrolyte layer 43 may include a support. The support may be a three-dimensional structure such as mesh, woven fabric, non-woven fabric, an embossed body, a punched body, an expanded body, or foam. The first solid electrolyte layer 43 does not necessarily include the above-described support.

The solid electrolyte material forming the first solid electrolyte layer 43 is preferably in the form of particle. The particle size (D50, median size) of the solid electrolyte material forming the first solid electrolyte layer 43 is preferably 0.1 μm or more and 3 μm or less.

The thickness of the first solid electrolyte layer 43 is 3 to 8.5 μm. With this configuration, the first solid electrolyte layer 43 can be sufficiently decreased in thickness, and the function thereof can be fulfilled.

The second solid electrolyte layer 42 is disposed between the first solid electrolyte layer 43 and the third solid electrolyte layer 41. For the second solid electrolyte layer 42, adhesiveness to the first solid electrolyte layer 43 and the third solid electrolyte layer 41 is required. A type of material similar to that of the first solid electrolyte layer can be used as the type of material forming the second solid electrolyte layer 42.

The second solid electrolyte layer 42 preferably contains at least any of a fluorine-based binder or a styrene-based binder (for example, SBR). Since the second solid electrolyte layer 42 contains the fluorine-based binder, bondability between the second solid electrolyte layer 42 and the other solid electrolyte layers can be improved. Since the second solid electrolyte layer 42 contains the styrene-based binder, ion conductivity can be improved. The content of the binder in the second solid electrolyte layer 42 is preferably 5% by volume or more and 25% by volume or less.

As in the first solid electrolyte layer 43, the second solid electrolyte layer 42 may include a support. The second solid electrolyte layer 42 does not necessarily include the support.

The thickness of the second solid electrolyte layer 42 is 10 to 20 μm. With this configuration, the second solid electrolyte layer 42 can be sufficiently decreased in thickness, and the function thereof can be fulfilled. Note that in a case where the second solid electrolyte layer 42 includes the support, the lower limit of the thickness of the second solid electrolyte layer 42 may be the thickness of the support+1 μm (a layer of 0.5 μm or more is formed on each lamination surface of the support). Thus, depending on the thickness of the support, the lower limit of the thickness of the second solid electrolyte layer 42 can be further decreased.

The third solid electrolyte layer 41 is disposed on the negative electrode layer 2 side. In the present embodiment, the third solid electrolyte layer 41 is disposed adjacent to the intermediate layer 5 on the negative electrode layer 2 side. The third solid electrolyte layer 41 preferably has such properties that the third solid electrolyte layer 41 is stretchable so as to follow stretch of the negative electrode layer 2 in pressing thereof. A type of material similar to that of the first solid electrolyte layer 43 can be used as the type of material forming the third solid electrolyte layer 41.

The amount of a binder contained in the third solid electrolyte layer 41 is less than those of the first solid electrolyte layer 43 and the second solid electrolyte layer 42. The amount of the binder contained in the third solid electrolyte layer 41 is preferably 2.7% by volume or more and 10% by volume or less.

As in the first solid electrolyte layer 43, the third solid electrolyte layer 41 may include a support. The third solid electrolyte layer 41 does not necessarily include the support.

The thickness of the third solid electrolyte layer 41 is 3 to 8.5 μm. With this configuration, the third solid electrolyte layer 41 can be sufficiently decreased in thickness, and the function thereof can be fulfilled.

### (Negative Electrode Layer)

The negative electrode layer 2 has a negative electrode active material layer 21 and a negative electrode current collector layer 22. The negative electrode active material layer 21 is not particularly limited but may be composed of a substance available as a negative electrode active material of a solid-state battery. The negative electrode active material layer 21 is preferably a lithium metal layer containing lithium metal as a negative electrode active material. This is because the negative electrode active material layer 21 can closely adhere to the solid electrolyte layer 4 with high adhesion force in the solid-state battery 1 according to the present invention even in a case where the negative electrode active material layer 21 is made of hard metal. Examples of the lithium metal include, in addition to lithium metal alone, a lithium alloy and the like. The negative electrode active material layer 21 may be composed of, other than the materials above, a silicon-based active material such as Si or a Si alloy, a lithium transition metal oxide such as lithium titanate (Li₄Ti₅O₁₂), a transition metal oxide such as TiO₂, Nb₂O₃, or WO₃, a metal sulfide, a metal nitride, a carbon material such as graphite, soft carbon, or hard carbon, or metallic indium, for example.

The negative electrode active material layer 21 may contain, in addition to the materials above, a material containable in a negative electrode active material layer of a solid-state battery. Examples of the above-described material include a solid electrolyte, a conductive auxiliary agent, a binder, and the like. The solid electrolyte includes those similar to the solid electrolytes contained in the solid electrolyte layer 4. Examples of the conductive auxiliary agent include carbon black, natural graphite, a carbon fiber, a carbon nanotube, and the like. Examples of the binder include a fluorine-based polymer, a nitrile-based polymer, a polyester-based polymer, an acrylate-based polymer, a cellulose-based polymer, a styrene-based polymer such as a styrene-butadiene-based polymer, a vinyl acetate-based polymer, a urethane-based polymer, a fluoroethylene-based copolymer, and the like.

The negative electrode current collector layer 22 is not particularly limited but may be composed of copper, nickel, stainless steel, aluminum (Al), or the like. Examples of the form of the negative electrode current collector layer 22 include the forms of foil, plate, mesh, non-woven fabric, foam, and the like. Part of the negative electrode current collector layer 22 is extended in a predetermined direction, thereby forming a negative electrode current collector tab 22a.

### (Positive Electrode Layer)

The positive electrode layer 3 has the positive electrode active material layer 31 and a positive electrode current collector layer 32. In the present embodiment, the positive electrode layer 3 has a configuration in which two positive electrode active material layers 31 are laminated on both surfaces of one positive electrode current collector layer 32. The configuration of the positive electrode layer 3 is not limited to above, and may have a configuration in which one positive electrode active material layer 31 is laminated on one surface of one positive electrode current collector layer 32.

The positive electrode active material layer 31 is not particularly limited but may be composed of a substance available as a positive electrode active material of a solid-state battery. Examples of a positive electrode active material forming the positive electrode active material layer 31 include a layered positive electrode active material particle of, for example, LiCoO₂, LiNiO₂, LiCoₓNi_{y}Mn_{z}O₂ (x+y+z=1), LiVO₂, or LiCrO₂, a spinel type positive electrode active material such as LiMn₂O₄, Li(Ni_{0.25}Mn_{0.75})₂O₄, LiCoMnO₄, or Li₂NiMn₃O₈, an olivine type positive electrode active material such as LiCoPO₄, LiMnPO₄, or LiFePO₄, solid solution oxide (Li₂MnO₃—LiMO₂ (M=Co, Ni, for example)), a conductive polymer such as polyaniline or polypyrrole, a sulfide such as Li₂S, CuS, a Li—Cu—S compound, TiS₂, FeS, MOS₂, or a Li—Mo—S compound, a mixture of sulfur and carbon, and the like. The above-described positive electrode active materials may be used alone, or two or more types of these materials may be used in combination.

An insulating frame 6 may be provided at the outer periphery of the positive electrode active material layer 31. The insulating frame 6 can prevent short-circuit of the solid-state battery 1, and can improve strength. In the present embodiment, the insulating frame 6 is disposed so as to cover the side surfaces of the two positive electrode active material layers 31 formed on both surfaces of the positive electrode current collector layer 32. Moreover, the insulating frame 6 contacts part of lamination surfaces of the positive electrode current collector layer 32, and has a gap in which a positive electrode current collector tab 32a to be described later extends. A material forming the insulating frame 6 is not particularly limited but may include an insulating oxide such as alumina, a resin such as polyvinylidene fluoride (PVDF), a rubber such as styrene-butadiene rubber (SBR), or the like.

The positive electrode current collector layer 32 is not particularly limited but may be composed of aluminum, stainless steel, conductive carbon (for example, graphite or carbon nanotubes), or the like. Examples of the form of the positive electrode current collector layer 32 include the forms of foil, plate, mesh, non-woven fabric, foam, and the like. Part of the positive electrode current collector layer 32 is extended in a predetermined direction, thereby forming the positive electrode current collector tab 32a.

### (Intermediate Layer)

The intermediate layer 5 is arbitrarily disposed between the negative electrode layer 2 and the solid electrolyte layer 4. The intermediate layer 5 has, for example, a function of causing lithium metal to uniformly precipitate in a case where the solid-state battery 1 is a lithium metal battery. Thus, an interface between the intermediate layer 5 and the solid electrolyte layer 4 is stabilized. In a case where the solid-state battery 1 is a lithium metal secondary battery having an intermediate layer 5, the solid-state battery 1 may be an anode-free battery in which no negative electrode active material layer 21 is present upon initial charge. In this case, after initial charge and discharge, a lithium metal layer is formed as the negative electrode active material layer 21. Note that the solid-state battery 1 does not necessarily have the intermediate layer 5.

A substance forming the intermediate layer 5 is not particularly limited but may include a metal which can be alloyed with lithium, amorphous carbon, or the like. Examples of the metal which can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), indium (In), and the like. The metal which can be alloyed with lithium may be in the form of nanoparticle. Examples of the amorphous carbon include carbon blacks such as acetylene black, furnace black, and Ketjenblack, coke, activated carbon, and the like. The amorphous carbon may be easily-graphitizable carbon (soft carbon), or may be non-graphitizable carbon (hard carbon), a carbon nanotube (CNT), fullerene, or graphene. The intermediate layer may contain a binder in addition to the above-described substances.

The preferred embodiment of the present invention has been described above, but the present invention is not limited to the embodiment above. The solid-state battery 1 may have a configuration available for a solid-state battery, such as an exterior body, in addition to the electrode laminate shown in the FIGURE.

Hereinafter, the present invention will be described in more detail with reference to examples. The present invention is not limited to the contents of the examples below.

### EXAMPLES

### [Production of Solid Electrolyte Sheet]

Fluid dispersion of a sulfide solid electrolyte (D50: 0.1 to 3 μm) was applied and dried, and in this manner, a solid electrolyte sheet was produced. The fluid dispersion was blended with a binder in an amount shown in Table 1 below in addition to the solid electrolyte. Note that a non-woven fabric base having a thickness of 9 μm was used as a support (base). When an attempt was made to produce, using the non-woven fabric base, a solid electrolyte sheet having a thickness equal to or less than that of the base, the sheet was not able to be produced due to, for example, breakage.

### [Production of Positive Electrode Layer]

As a positive electrode current collector, aluminum foil having a thickness of 12.0 μm was prepared. As a positive electrode active material, 60.0 parts by mass of lithium-nickel-cobalt-manganese composite oxide (NCM622), 35.8 parts by mass of a sulfide solid electrolyte as a solid electrolyte, 2.9 parts by mass of acetylene black (DENKA BLACK (registered trademark) Li-100 manufactured by Denka Company Limited) as a conductive auxiliary agent, and 1.3 parts by mass of a styrene-butadiene rubber-based (SBR-based) binder were mixed. The resultant mixture was dispersed in a solvent, and in this manner, a positive electrode active material slurry was prepared. The resultant positive electrode active material slurry was applied to and dried on both surfaces of the positive electrode current collector by a bar coater such that the basis weight thereof after drying becomes 27.4 mg/cm², and in this manner, a positive electrode layer was produced.

### [Production of Negative Electrode Layer]

As a negative electrode current collector, copper foil having a thickness of 10 μm was prepared. Metal lithium foil having a thickness of 6.5 μm was laminated on a surface of the copper foil, and in this manner, a negative electrode layer was produced.

### [Production of Solid-State Battery Cell]

The positive electrode layer, solid electrolyte layer, negative electrode layer obtained as described above were laminated on and press-joined to each other, and in this manner, an electrode laminate was produced. A test solid-state battery cell was produced using the resultant electrode laminate.

### [Cell Charge-Discharge Test]

Using the test solid-state battery cell obtained as described above, a charge-discharge test was conducted with a voltage range of 2.65 to 4.3 V. A cell having a second charge-discharge capacity of 95% or higher with respect to an initial charge-discharge capacity was taken as pass indicated by “2”. A cell having a capacity of lower than 95% was taken as fail indicated by “1”. Results are shown in Table 1.

### [Voltage Measurement]

The test solid-state battery cell obtained as described above was fully charged, and thereafter, was left stand for 24 hours. Then, voltages after a lapse of 20 hours and a lapse of 24 hours were measured. A cell having a voltage difference (ΔV/h) of 1.5 mV or less was taken as pass indicated by “2”, and a cell having a voltage difference of more than 1.5 mV was taken as fail indicated by “1”. Results are shown in Table 1.

TABLE 1

| | First Solid Electrolyte Layer | | | | Second Solid Electrolyte Layer | | | | | Third Solid Electrolyte Layer | | | | | |
|---|---|---|---|---|---|---|---|---|---|---|---|---|---|---|---|
| | | | Solid | | | | Solid | | | | | Solid | | Cell | Volt- |
| | | | Elec- | | | | Elec- | | | | | Elec- | | Charge- | age |
| | Binder | | trolyte | Thick- | Binder | | trolyte | | Thick- | Binder | | trolyte | Thick- | Dis- | Mea- |
| | | [wt/ | D50 | ness | | [wt/ | D50 | | ness | | [wt/ | D50 | ness | charge | sure- |
| | Type | vol %] | (μm) | [μm] | Type | vol %] | (μm) | Base | [μm] | Type | vol %] | (μm) | [μm] | Test | ment |
| Example1 | PVdF | 4.3/5.0 | 0.1 | 3 | PVdF | 4.3/5.0 | 0.1 | Absent | 11 | PVdF | 4.3/5.0 | 0.1 | 3 | 2 | 2 |
| Example2 | PVdF | 4.3/5.0 | 0.7 | 3 | PVdF | 4.3/5.0 | 0.7 | Absent | 11 | PVdF | 4.3/5.0 | 0.7 | 3 | 2 | 2 |
| Example3 | PVdF | 4.3/5.0 | 3 | 3 | PVdF | 4.3/5.0 | 3 | Absent | 11 | PVdF | 4.3/5.0 | 0.7 | 3 | 2 | 2 |
| Example4 | PVdF | 4.3/5.0 | 0.7 | 3 | SBR | 5.5/11 | 0.7 | Pre- | 11 | SBR | 1.3/2.7 | 0.7 | 3 | 2 | 2 |
| | | | | | | | | sent | | | | | | | |
| Example5 | SBR | 1.3/2.7 | 0.7 | 3 | SBR | 10/19.1 | 0.7 | Pre- | 11 | SBR | 1.3/2.7 | 0.7 | 3 | 2 | 2 |
| | | | | | | | | sent | | | | | | | |
| Example6 | SBR | 1.3/2.7 | 0.7 | 3 | SBR | 5.5/11 | 0.7 | Pre- | 11 | PVdF | 4.3/5.0 | 0.7 | 3 | 2 | 2 |
| | | | | | | | | sent | | | | | | | |
| Example7 | PVdF | 6.5/7.5 | 0.7 | 3 | PVdF | 8.7/10 | 0.1 | Pre- | 11 | PVdF | 2.3/2.7 | 0.7 | 3 | 2 | 2 |
| | | | | | | | | sent | | | | | | | |
| Example8 | PVdF | 13.2/15 | 0.7 | 3 | SBR | 10/19.1 | 0.1 | Pre- | 11 | SBR | 1.3/2.7 | 0.7 | 3 | 2 | 2 |
| | | | | | | | | sent | | | | | | | |
| Example9 | PVdF | 8.7/10 | 0.1 | 3 | PVdF | 8.7/10 | 0.1 | Pre- | 11 | PVdF | 8.7/10 | 0.1 | 3 | 2 | 2 |
| | | | | | | | | sent | | | | | | | |
| Example10 | PVdF | 22.3/25 | 0.7 | 3 | SBR | 10/19.1 | 0.7 | Pre- | 11 | SBR | 1.3/2.7 | 0.7 | 3 | 2 | 2 |
| | | | | | | | | sent | | | | | | | |
| Example11 | PVdF | 22.3/25 | 0.7 | 5 | SBR | 10/19.1 | 0.7 | Pre- | 11 | SBR | 1.3/2.7 | 0.7 | 3 | 2 | 2 |
| | | | | | | | | sent | | | | | | | |
| Example12 | PVdF | 22.3/25 | 0.7 | 3 | PVdF | 22.3/25 | 0.7 | Absent | 11 | PVdF | 2.3/2.7 | 0.7 | 3 | 2 | 2 |
| Example13 | PVdF | 22.3/25 | 0.7 | 3 | PVdF | 22.3/25 | 0.7 | Absent | 20 | PVdF | 2.3/2.7 | 0.7 | 3 | 2 | 2 |

### EXPLANATION OF REFERENCE NUMERALS

1 Solid-State Battery
2 Negative Electrode Layer
3 Positive Electrode Layer
4 Solid Electrolyte Layer
41 Third Solid Electrolyte Layer
42 Second Solid Electrolyte Layer
43 First Solid Electrolyte Layer

What is claimed is:

1. A solid-state battery comprising:
a structure in which a negative electrode layer, a solid electrolyte layer, and a positive electrode layer are laminated in this order,
wherein the solid electrolyte layer includes a first solid electrolyte layer, a second solid electrolyte layer, and a third solid electrolyte layer disposed in this order from a positive electrode layer side,
a thickness of the first solid electrolyte layer is 3 to 8.5 μm,
a thickness of the second solid electrolyte layer is 10 to 20 μm,
a thickness of the third solid electrolyte layer is 3 to 8.5 μm, and
a total thickness of the solid electrolyte layer is 17 to 26 μm.

2. The solid-state battery according to claim 1, wherein a content (% by volume) of a binder in the third solid electrolyte layer is equal to or less than a content (% by volume) of a binder in the first solid electrolyte layer and a content (% by volume) of a binder in the second solid electrolyte layer.

3. The solid-state battery according to claim 2, wherein the content of the binder in the first solid electrolyte layer is 5% by volume or more and 25% by volume or less.

4. The solid-state battery according to claim 2, wherein the first solid electrolyte layer contains a fluorine-based binder.

5. The solid-state battery according to claim 2, wherein the content of the binder in the second solid electrolyte layer is 5% by volume or more and 25% by volume or less.

6. The solid-state battery according to claim 5, wherein the second solid electrolyte layer contains at least any of a fluorine-based binder or a styrene-based binder.

7. The solid-state battery according to claim 2, wherein the content of the binder in the third solid electrolyte layer is 2.7% by volume or more and 10% by volume or less.

8. The solid-state battery according to claim 1, wherein at least any of the first solid electrolyte layer, the second solid electrolyte layer, or the third solid electrolyte layer includes a support.

9. The solid-state battery according to claim 1, wherein a particle size (D50) of a solid electrolyte layer particle contained in the solid electrolyte layer is 0.1 μm or more and 3 μm or less.
